(19) United States
(12) Patent Application Publication
(10) Pub. No.: US 2016/0127629 A1
(43) Pub. Date: May 5, 2016

(54) DIGITAL IMAGE CAPTURE DEVICE HAVING AN IMAGE SENSOR MECHANISM TO COMPENSATE FOR OCCURRENCES OF EXPOSURE BLOWOUTS

(71) Applicant: NATIONAL CENTRAL UNIVERSITY, TAOYUAN COUNTY (TW)

(72) Inventors: CHING-CHERNG SUN, TAOYUAN COUNTY (TW); KO-TING CHENG, CHIAYI CITY (TW); TSUNG-HSUN YANG, HSINCHU CITY (TW); CHAO-WEN LIANG, TAICHUNG CITY (TW)

(21) Appl. No.: 14/532,198

(22) Filed: Nov. 4, 2014

(51) Int. Cl. H04N 5/235; G02F 1/133; G02F 1/1334

(52) U.S. Cl. CPC H04N 5/2351; H04N 5/2353; G02F 1/1334; G02F 1/13318

(57) ABSTRACT

An image sensor mechanism for use in a digital image capture device. The mechanism generally includes a photo sensor array, a liquid crystal light valve array, and a control module. The liquid crystal light valve array is operatively disposed in front of the photo sensor array and includes a plurality of light valves, each of which is independently controllable and corresponds to at least one pixel sensor of the photo sensor array so as to selectively prevent light from reaching the photo sensor array. The control module is electrically coupled to the liquid crystal light valve array and the photo sensor array for applying a variable electric field across each of the light valves and for selectively adjusting the light valves with different transmittances based on a preliminary image previously captured by the photo sensor array in order to transform the preliminary image into a resultant image to be re-captured by the photo sensor array.

### BACKGROUND OF THE INVENTION

1. Field of the Invention

The present invention relates to a digital image capture device, and more particularly to a digital image capture device having an image sensor mechanism for exposure compensation.

2. Description of the Related Art

A digital image capture device, such as digital camera, is similar to a film camera except that the film is replaced with an electronic sensor. The sensor is comprised of an array of photo sensors that change the photons that strike them into electrons providing a signal at each pixel proportional to the number of photons. Presently, most digital cameras employ Charge Coupled Device (CCD) or Complementary Metal Oxide Semiconductor (CMOS) sensors. One of the advantages of the digital cameras is their ability to capture images of objects for later manipulation by computer graphics programs. However, digital cameras have a limited dynamic range of exposure sensitivity due to the use of CCD or CMOS sensors. Thus, unlike conventional photographic exposure that captures shadow detail without washing-out image highlights in a high contrast scene, a digital camera will lose a substantial amount of detail in either the darkest areas of the image, or in the brightest areas, or both.

For example, as discussed in U.S. Pat. No. 8,493,500, every auto exposure algorithm can potentially produce a wrong exposure for a given scene. In some cases, overexposure can be caused by the particular subject matter composition of the scene. Overexposure in such images may actually cause the brightest areas of the image to be “blown out,” that is, the brightness of pixels in those areas may exceed the sensor's dynamic range of capturing capability, thus losing all information in those areas of the image and producing only pure white pixels in the resultant image. Likewise, underexposure in an image may actually cause the darkest areas of the image to be “blown out,” that is, the darkness of pixels in those areas may exceed the sensor's dynamic range of capturing capability, thus losing all information in those areas of the image and producing only pure black pixels in the resultant image.

Under certain circumstances, it is an inescapable consequence of auto exposure algorithms that some scenes will end up being exposed in a suboptimal way. To solve the problem, a conventional “blowout prevention” stage is provided in the image processing pipeline in conjunction with the automatic exposure (and gain) control that would be capable of correcting the camera's exposure settings in an effort to reduce unwanted or unintentional exposure blowouts. This conventional “blowout prevention” stage may be applied to a case where either an overexposure or a underexposure occurs in an image, by increasing or reducing the total amount of light into the sensor, e.g., increased exposure time, increased gain levels, etc. However, if both an overexposure and a underexposure occur in an image, it becomes a challenge to solve the blowouts problem. Thus, it would be desired to have an improved “blowout prevention” mechanism that would be capable of correcting the camera's exposure in an effort to reduce unwanted or unintentional exposure blowouts, even if in the case where both the overexposure and the underexposure occur in the image.

### SUMMARY OF THE INVENTION

Accordingly, it is an object of the present invention to provide a digital image capture device with an image sensor mechanism for exposure blowout prevention. In other words, the image sensor mechanism may be applied in the digital image capture device, such as a digital camera, a mobile phone, a video event data recorder, a surveillance camera, or the like, to compensate for occurrences of exposure blowouts.

Specifically, the image sensor mechanism includes a photo sensor array, a liquid crystal light valve array and a control module. The liquid crystal light valve array is operatively disposed in front of the photo sensor array and includes a plurality of light valves, each of which is independently controllable and corresponds to at least one pixel of the photo sensor array so as to selectively prevent light from reaching the pho to sensor array. Additionally, the control module is electrically coupled to the liquid crystal light valve array and the photo sensor array for applying a variable electric field across each of the light valves, and for selectively adjusting the light valves with different transmittances based on a preliminary image previously captured by the photo sensor array in order to transform the preliminary image into a resultant image to be re-captured by the photo sensor array.

More specifically, the control module is configured to determine if a blowout region is presented in the preliminary image captured by the photo sensor array. If yes, the control module selectively increases or decreases transmittances of some of the light valves corresponding the blowout region in the preliminary image so as to transform the preliminary image into the resultant image.

In one embodiment, the liquid crystal light valve array includes front and rear substrates disposed substantially parallel, and a liquid crystal layer interposed between the front and the rear substrates. The liquid crystal layer is divided into a plurality of liquid crystal cells for the respective light valves. Each of the light valves includes first and second electrodes respectively disposed on the front and rear substrates. The control module includes a driving circuit connected to the first and second electrodes to apply a vertical electric field for each of the liquid crystal cells in the liquid crystal layer. In this case, the liquid crystal light valve array may be directly attached to the photo sensor array.

In another embodiment, the liquid crystal light valve array is directly built onto the photo sensor array. That is, the liquid crystal light valve array employs only one substrate. A liquid crystal layer is interposed between the substrate and the photo sensor array. The first and second electrodes disposed on the substrate. And the control module includes a driving circuit connected to the first and second electrodes for applying a horizontal electric field for each liquid crystal cell in the liquid crystal layer. Note that if a PDLC material is employed for the liquid crystal layer in which a horizontal electric field is to be applied, and a polarizer may have to be disposed on the substrate.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1 illustrates a simplified functional block diagram of an image sensor mechanism of a digital image capture device in accordance with a first embodiment of the present invention;

FIG. 2 shows a preliminary image captured by the image sensor mechanism of the digital image capture device;

FIG. 3 shows a resultant image re-captured by the image sensor mechanism of the digital image capture device;

FIG. 4 is a perspective view of an image sensor mechanism of the digital image capture device shown in FIG. 1;

FIG. 5 is a view similar to FIG. 4 except that a vertical electric field is applied to a light valve of the image sensor mechanism;

FIG. 6 is a plot showing the variation in transmittance with the voltage applied to the light valve of the image sensor mechanism;

FIG. 7 is a perspective view of an image sensor mechanism of the digital image capture device in accordance with a second embodiment of the present invention; and

FIG. 8 is a view similar to FIG. 7 except that a horizontal electric field is applied a light valve of the image sensor mechanism.

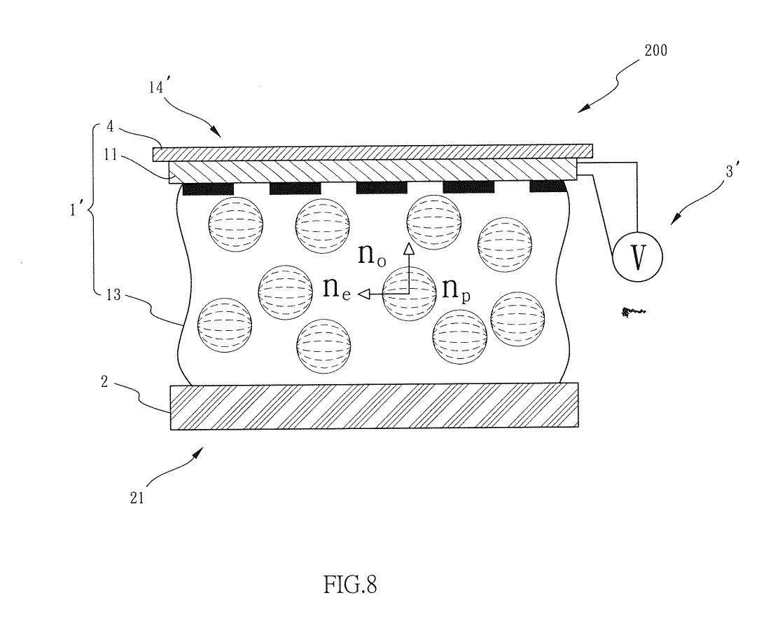

### DETAILED DESCRIPTION OF EMBODIMENTS

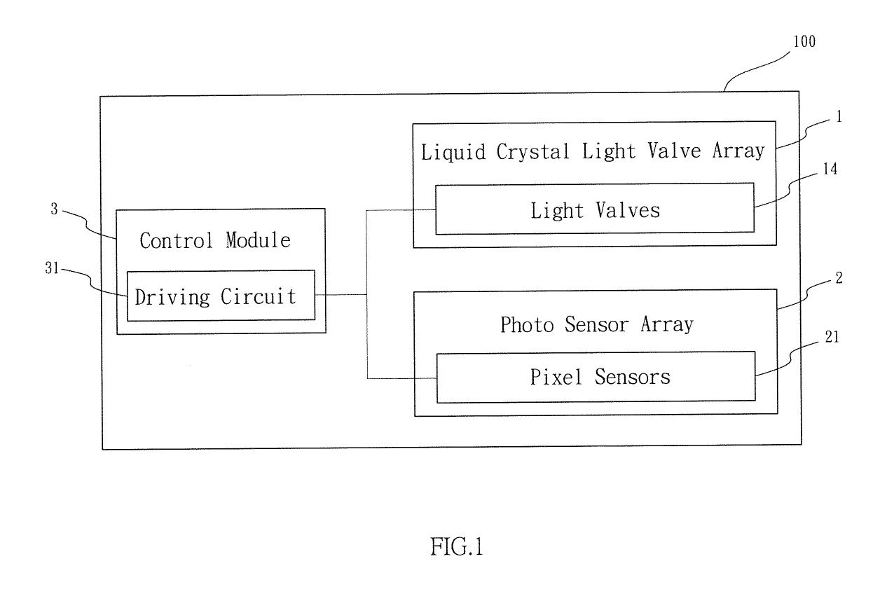

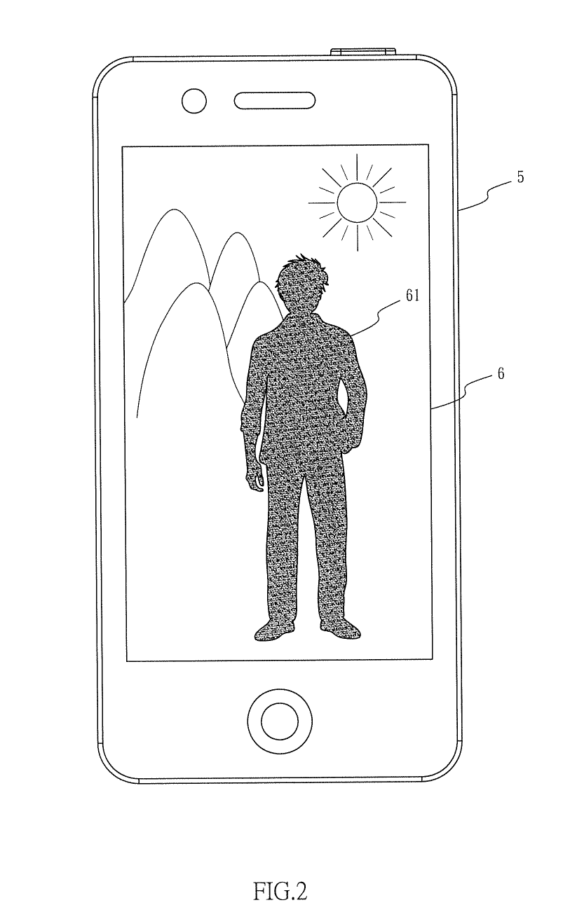

Referring to FIGS. 1 and 2, there is shown a first embodiment of the image sensor mechanism 100 for use in a digital image capture device 5, such as a mobile phone, a digital camera, a video event data recorder, a surveillance camera, or the like, to compensate for occurrences of exposure blowouts. That is, the darkness (or brightness) of pixels in those areas may exceed the sensor's dynamic range of capturing capability, thus losing all information in those areas of the image and producing only pure black (or white) pixels in the image, as shown in FIG. 2.

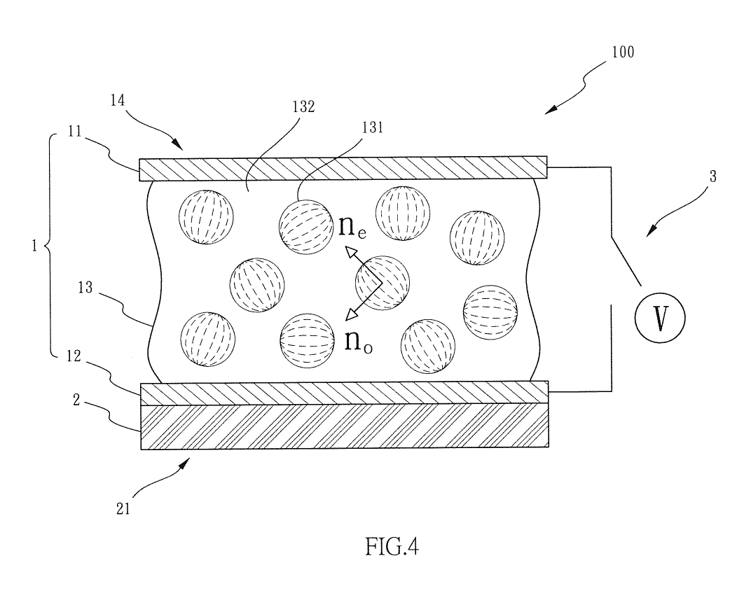

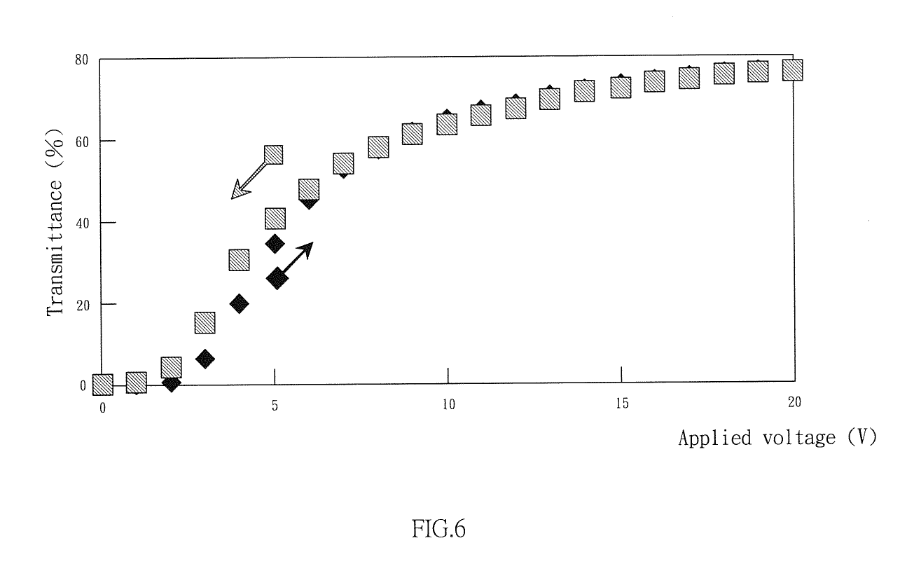

The image sensor mechanism 100 generally includes a liquid crystal light valve array 1, a photo sensor array 2 and a control module 3. With reference to FIG. 4 and further referring to FIG. 1, the liquid crystal light valve array 1 is operatively disposed in front of the photo sensor array 2. The liquid crystal light valve array 1 includes a plurality of light valves 14 (only one is shown), each of which is independently controllable and corresponds to at least one pixel sensor 21 of the photo sensor array 2 so as to selectively prevent light from reaching the photo sensor array 2. The control module 3 is electrically coupled to the liquid crystal light valve array 1 and the photo sensor array 2. The control module 3 has a driving circuit 31 for applying a variable electric field across each of the light valves 14 to control transmittance of each light valve 14. As shown in FIG. 6, the control module 3 may selectively adjust each of the light valves 14 with a variable transmittance by applying a voltage to the light valve 14.

Each of the light valves 14 with a size of 50 μm×50 μm may corresponds to a group of pixel sensors 21 of the photo sensor array 2, each of which has a dimension of 10 μm×10 μm. Preferably, each of the light valves 14 corresponds to a single pixel sensor 21 of the photo sensor array 2 for higher resolution. It should also be noted that a color subpixel (red, green and blue, RGB) in a full color pixel may refer to as a single pixel sensor 21 in this invention.

As shown in FIG. 4, the liquid crystal light valve array 1 includes front and rear substrates 11, 12 disposed substantially parallel, and a liquid crystal layer 13 interposed between the front and the rear substrates 11, 12. The liquid crystal layer 13 are divided into a plurality of liquid crystal cells (not numbered) for the respective light valves 14. Moreover, the liquid crystal layer 13 includes a polymer-dispersed liquid crystal (PDLC) material. The PDLC material comprises droplets of liquid crystal material 131 dispersed in a polymer matrix 132, as known in the art. The front and rear substrates 11, 12, usually glass substrates, are coated with a suitable dielectric material (not shown) to form electrodes which enable a voltage to be applied across the liquid crystal cell. Typically, the dielectric material may be indium tin oxide (ITO) or any other transparent dielectric material. In this embodiment, the electrodes (not shown) are respectively disposed on the front and rear substrates 11, 12. The driving circuit 31 of the control module 3 is connected to the electrodes to apply a vertical electric field for each of the liquid crystal cells in the liquid crystal layer 13. Thus, the control module 3 may selectively adjust each of the light valves 14 with a variable transmittance by applying a voltage to the PDLC cell.

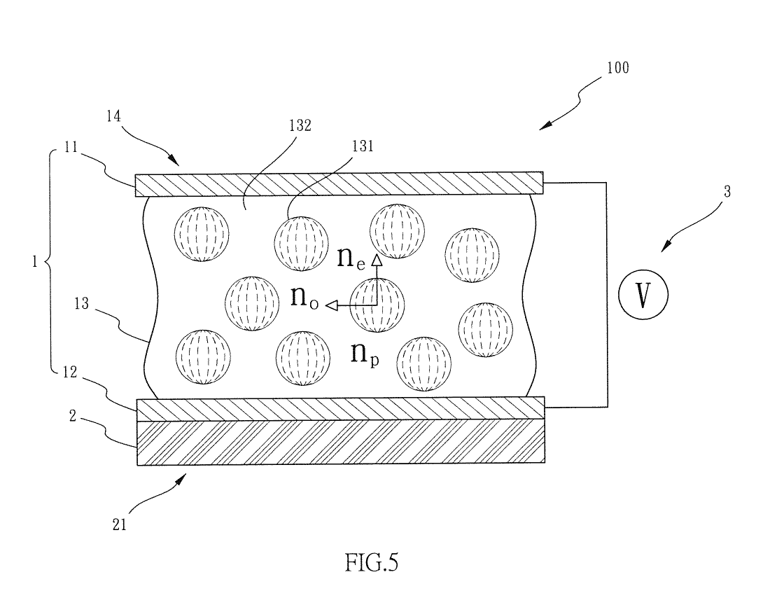

The working principle of Polymer Dispersed Liquid Crystal (PDLC) display is briefly explained below. In the off state as in FIG. 4, the droplets 131 are randomly aligned, the extraordinary refractive index (nₑ) seen by the light will be different from the refractive index of the polymer (nₚ), hence the light is scattered or reflected in a large angle towards the viewer. In the on state, as shown in FIG. 5, the liquid crystal molecules orient uniformly along the direction of the applied field, therefore the ordinary refractive index (nₒ) is the refractive index seen by the light, and usually nₚ is chosen as nₚ˜nₒ, for this index matched situation, light can be transmitted with a very high transmission.

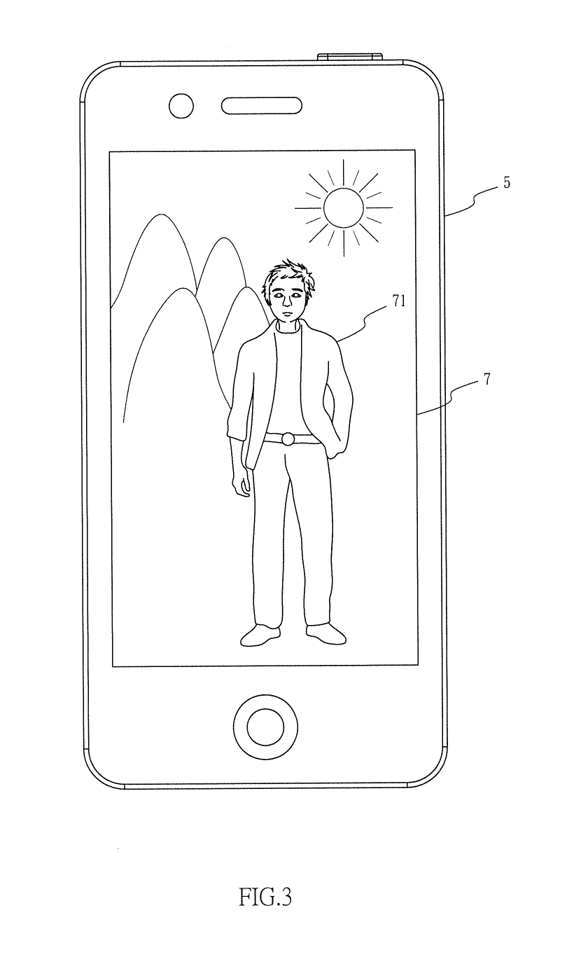

More specifically, the control module 3 is configured to apply a first electric field across each of the light valves 14 for the photo sensor array 2 to capture a preliminary image 6, as depicted in FIG. 2, and a second electric field for the same to capture a resultant image 7, as depicted in FIG. 3, as will be discussed in detail later.

For instance, as shown in FIG. 2, the control module 3 is acknowledged a blowout region 61 presented in the preliminary image 6 captured by the photo sensor array 2. The darkness of pixels in the region 61 exceeds a dynamic range of the associated pixel sensors 21 of the photo sensor array 2. At this time, the control module 3 selectively increases transmittances of the associated light valves 14 corresponding the blowout region 61 of the preliminary image 6 so that more light is allowed to pass through the selected light valves 14 to form a brighter region 71 in which a shadow detail is captured, as shown in FIG. 3, in lieu of the blowout region 61.

In other words, the control module 3 may selectively adjust the light valves 14 with different transmittances based on the preliminary image 6 previously captured by the photo sensor array 2 in order to transform the preliminary image 6 into the resultant image 7, thereby compensating for the occurrence of the exposure blowout.

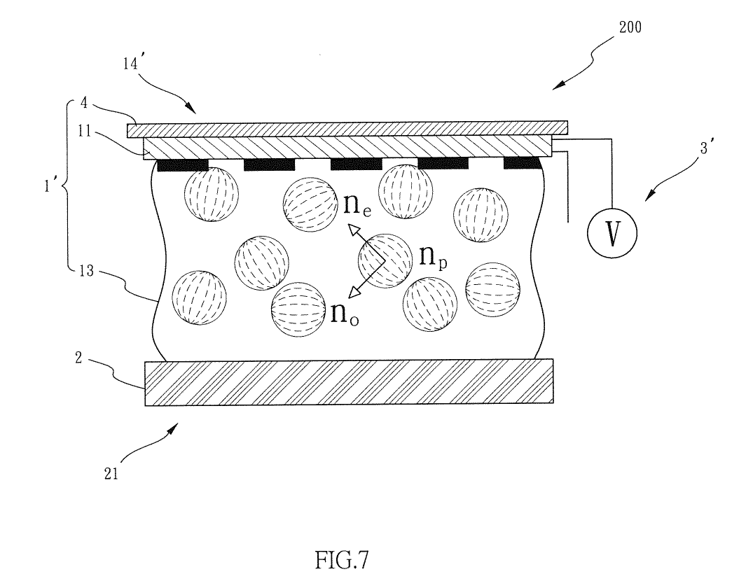

Referring now to FIG. 7, an image sensor mechanism 200 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

Specifically, the liquid crystal light valve array 200 includes a front substrate 4, and a liquid crystal layer 13 interposed between the front substrate 4 and the photo sensor array 2. The liquid crystal layer 3 are divided into a plurality of liquid crystal cells for the respective light valves 14′. Each of the light valves 14 includes first and second electrodes both disposed on the front substrate 4. The control module 3′ includes a driving circuit connected to the first and second electrodes to apply a horizontal electric field for each of the liquid crystal cells in the liquid crystal layer 13. A method of generating the horizontal electric field is substantially the same as that of an in-plane switching mode LCD and detailed description thereof is omitted. Additionally, due to the use of the PDLC material, the liquid crystal light valve array 1′ may further need a polarizer 4 disposed on the front substrate 4 to function as desired.

1. An image sensor mechanism, comprising:
a photo sensor array;
a liquid crystal light valve array attached on the photo sensor array and including a plurality of light valves, each of which independently controllable and corresponding to at least one pixel sensor of the photo sensor array so as to selectively prevent light from reaching the photo sensor array; and
a control module electrically coupled to the liquid crystal light valve array and the photo sensor array for applying a variable electric field across each of the light valves and for selectively adjusting the light valves with different transmittances based on a preliminary image previously captured by the photo sensor array in order to transform the preliminary image into a resultant image to be re-captured by the photo sensor array.

2. An image sensor mechanism as recited in claim 1, wherein the control module is configured to apply a first electric field for the photo sensor array to capture the preliminary image, and a second electric field for the same to capture the resultant image.

3. An image sensor mechanism as recited in claim 2, wherein the control module is configured to determine if a blowout region is presented in the preliminary image captured by the photo sensor array; and if yes, the control module selectively increases or decreases transmittances of some of the light valves corresponding the blowout region in the preliminary image so as to transform the preliminary image into the resultant image.

4. An image sensor mechanism as recited in claim 1, wherein each of the light valves corresponds to a single pixel sensor of the photo sensor array.

5. An image sensor mechanism as recited in claim 1, wherein each of the light valves corresponds to a group of pixel sensors of the photo sensor array.

6. An image sensor mechanism as recited in claim 1, wherein the liquid crystal light valve array includes front and rear substrates disposed substantially parallel, and a liquid crystal layer interposed between the front and the rear substrates; the liquid crystal layer are divided into a plurality of liquid crystal cells for the respective light valves; each of the light valves includes first and second electrodes respectively disposed on the front and rear substrates; and the control module includes a driving circuit connected to the first and second electrodes to apply a vertical electric field for each of the liquid crystal cells in the liquid crystal layer.

7. An image sensor mechanism as recited in claim 6, wherein the liquid crystal layer includes a polymer-dispersed liquid crystal (PDLC) material.

8. An image sensor mechanism as recited in claim 1, wherein the liquid crystal light valve array includes a front substrate, and a liquid crystal layer interposed between the front substrate and the photo sensor array; the liquid crystal layer are divided into a plurality of liquid crystal cells for the respective light valves; each of the light valves includes first and second electrodes disposed on the front substrate; and the control module includes a driving circuit connected to the first and second electrodes to apply a horizontal electric field for each of the liquid crystal cells in the liquid crystal layer.

9. An image sensor mechanism as recited in claim 8, wherein the liquid crystal layer includes a PDLC material, and the liquid crystal light valve array further includes a polarizer disposed on the front substrate.

10. A digital image capture device comprising the image sensor mechanism as recited in claim 3.

11. A digital image capture device as recited in claim 10, wherein the digital image capture device is a device selected from the group consisting of a digital camera, a mobile phone, a video event data recorder, and a surveillance camera.
